(19) United States
(12) Patent Application Publication
(10) Pub. No.: US 2018/0199311 A1
(43) Pub. Date: Jul. 12, 2018

(54) Alert Signal Design In Mobile Communications

(71) Applicant: MediaTek Inc., Hsinchu City (TW)

(72) Inventors: Weidong Yang, San Diego, CA (US); Chien-Hwa Hwang, Hsinchu City (TW); Pei-Kai Liao, Hsinchu City (TW)

(21) Appl. No.: 15/862,895

(22) Filed: Jan. 5, 2018

Related U.S. Application Data
(60) Provisional application No. 62/444,401, filed on Jan. 10, 2017.

(51) Int. Cl. H04W 68/02; H04W 72/04; H04W 68/00; H04W 72/12; H04W 28/06

(52) U.S. Cl. CPC H04W 68/02; H04W 72/0446; H04W 68/005; H04L 5/0007; H04W 72/1257; H04W 28/06; H04W 72/0406

(57) ABSTRACT

Various solutions for alert signal design with respect to user equipment and network apparatus in mobile communications are described. A first node of a wireless network may transmit an alert signal to a second node of the wireless network. The first node may further perform a mini-slot transmission to the second node. The alert signal indicates presence of the mini-slot transmission. The first node may also receive an alert signal from the second node. The first node may further detect a mini-slot transmission according to the alert signal and receive the mini-slot transmission from the second node.

### CROSS REFERENCE TO RELATED PATENT APPLICATION

The present disclosure claims the priority benefit of U.S. Provisional Patent Application No. 62/444,401, filed on 10 Jan. 2017, the content of which is incorporated by reference in its entirety.

### TECHNICAL FIELD

The present disclosure is generally related to mobile communications and, more particularly, to alert signal design with respect to with respect to user equipment and network apparatus in mobile communications.

### BACKGROUND

Unless otherwise indicated herein, approaches described in this section are not prior art to the claims listed below and are not admitted as prior art by inclusion in this section.

In wireless communication environment, the wireless signals transmitted or broadcasted by a node of a wireless network may cause interferences to neighbor nodes within neighbor areas. In order to prevent potential interferences, the plurality of nodes within neighbor areas may have to communicate and negotiate with each other to properly arrange radio resources. Accordingly, coordination information exchange among the plurality of nodes may be needed. The coordination information may comprise, for example and without limitation, slot format, uplink/downlink traffic amount, uplink/downlink resource split, channel state information (CSI) feedback, etc.

In newly developed communication systems or future communication systems, short slot is newly introduced to carry control information or data information. The short slot may be configured to occupy a small time duration in time domain and a plurality of sub-carriers in frequency domain. For example, the time duration of the short slot may comprise one or more than one orthogonal frequency-division multiplexing (OFDM) symbols. Thus, the node may be configured to use the short slot to transmit the coordination information among the plurality of nodes.

Such mechanism may also be used for the unlicensed spectrum such as 5 GHz unlicensed national information infrastructure (U-NII) radio band in US and the shared spectrum such as citizens broadband radio service (CBRS) radio band in US. However, the short slot transmission at one node may not be coordinated among other nodes and its timing and location in frequency domain may not be known in advance at other nodes. The complexity of blink detection at other nodes may be a huge burden. Especially in the unlicensed spectrum, the plurality of nodes in neighbor areas may not belong to the same operator network or service provider. The timing information of the nodes is not shared or aligned with each other. Without proper coordination information or timing information, the interferences among the nodes may become serious and uncontrollable.

In the case of service multiplexing of enhanced mobile broadband (eMBB) and ultra-reliable and low latency communications (URLLC), URLLC transmission may overlap with eMBB traffic. Due to the requirement on short latency for URLLC transmission, the transmitter of eMBB traffic and the intended recipient may not be able to utilize the scheduling based transmission as used in Long-Term Evolution (LTE) for URLLC transmission. Consequently, the detection of the incoming URLLC transmission with un-certain timing may be complicated.

Accordingly, it is important to properly avoid interferences caused by non-coordinated wireless signal transmission. Therefore, in developing communication system, it is needed to provide proper mechanisms for exchanging information among a plurality of nodes.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to exchanging information and URLLC transmission among a plurality of nodes with respect to with respect to user equipment and network apparatus in mobile communications.

In one aspect, a method may involve a first node of a wireless network transmitting an alert signal to a second node of the wireless network. The method may also involve the first node performing a mini-slot transmission to the second node. The alert signal indicates presence of the mini-slot transmission.

In one aspect, a method may involve a first node of a wireless network receiving an alert signal from a second node of the wireless network. The method may also involve the first node detecting a mini-slot transmission according to the alert signal. The method may further involve the first node receiving the mini-slot transmission from the second node. The alert signal indicates presence of the mini-slot transmission.

In one aspect, an apparatus may comprise a transceiver capable of wirelessly communicating with other apparatus of a wireless network. The apparatus may also comprise a processor communicatively operably coupled to the transceiver. The processor may be capable of transmitting an alert signal to the other apparatus. The processor may also be capable of performing a mini-slot transmission to the other apparatus. The alert signal indicates presence of the mini-slot transmission.

In one aspect, an apparatus may comprise a transceiver capable of wirelessly communicating with other apparatus of a wireless network. The apparatus may also comprise a processor communicatively operably coupled to the transceiver. The processor may be capable of receiving an alert signal from the other apparatus. The processor may also be capable of detecting a mini-slot transmission according to the alert signal. The processor may further be capable of receiving the mini-slot transmission from the other apparatus. The alert signal indicates presence of the mini-slot transmission.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR) and Internet-of-Things (IoT), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure, and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIGS. 1A-1B are diagrams depicting an example scenario under schemes in accordance with implementations of the present disclosure.

FIG. 2 is a diagram depicting an example scenario under schemes in accordance with implementations of the present disclosure.

FIG. 3 is a diagram depicting an example scenario under schemes in accordance with implementations of the present disclosure.

FIG. 4 is a diagram depicting an example scenario under schemes in accordance with implementations of the present disclosure.

FIG. 5 is a diagram depicting an example scenario under schemes in accordance with implementations of the present disclosure.

FIG. 6 is a block diagram of an example system in accordance with an implementation of the present disclosure.

FIG. 7 is a flowchart of an example process in accordance with an implementation of the present disclosure.

FIG. 8 is a flowchart of an example process in accordance with an implementation of the present disclosure.

### DETAILED DESCRIPTION OF PREFERRED EMBODIMENTS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to alert signal design with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

Under proposed schemes in accordance with the present disclosure, exchange of coordination information may occur among nodes in a wireless network. Each node in the wireless network may be a network apparatus (e.g., a base station (BS)) or a communication apparatus (e.g., a user equipment (UE)), and a UE may be engaged in communication with a BS, another UE, or both, at a given time. Thus, the exchange of coordination information may take place in three types of node pairs: BS-BS, BS-UE and UE-UE. Herein, a BS may be an eNB in an LTE-based network of a gNB in a 5G/NR network.

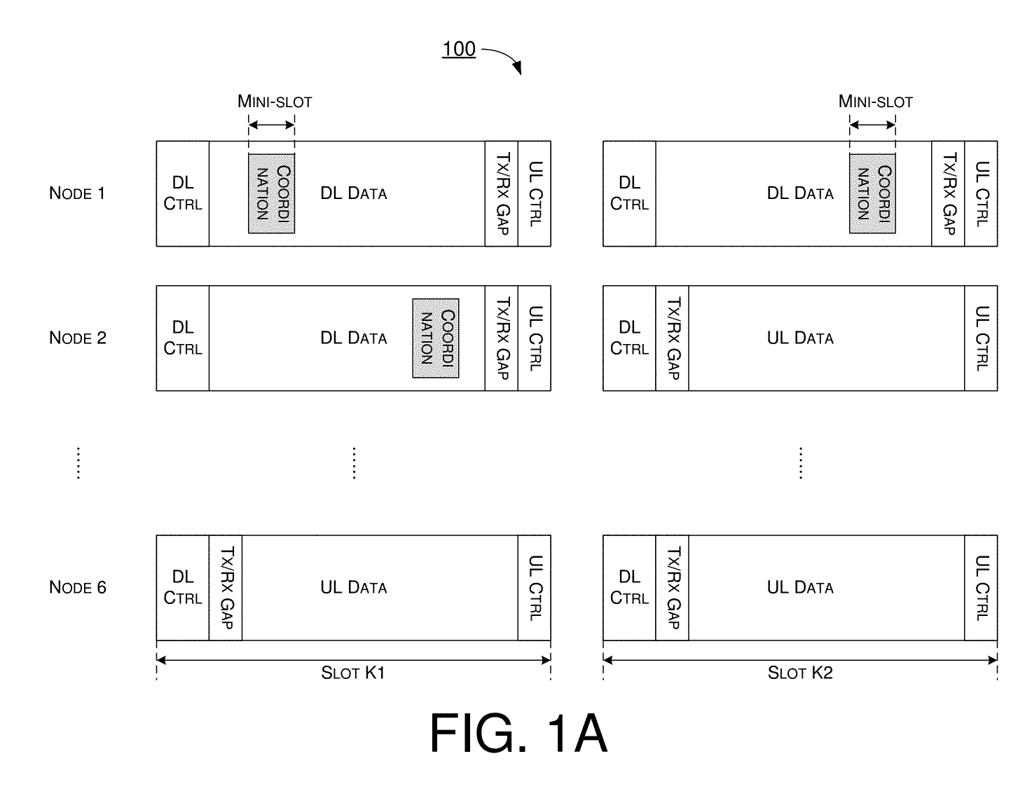

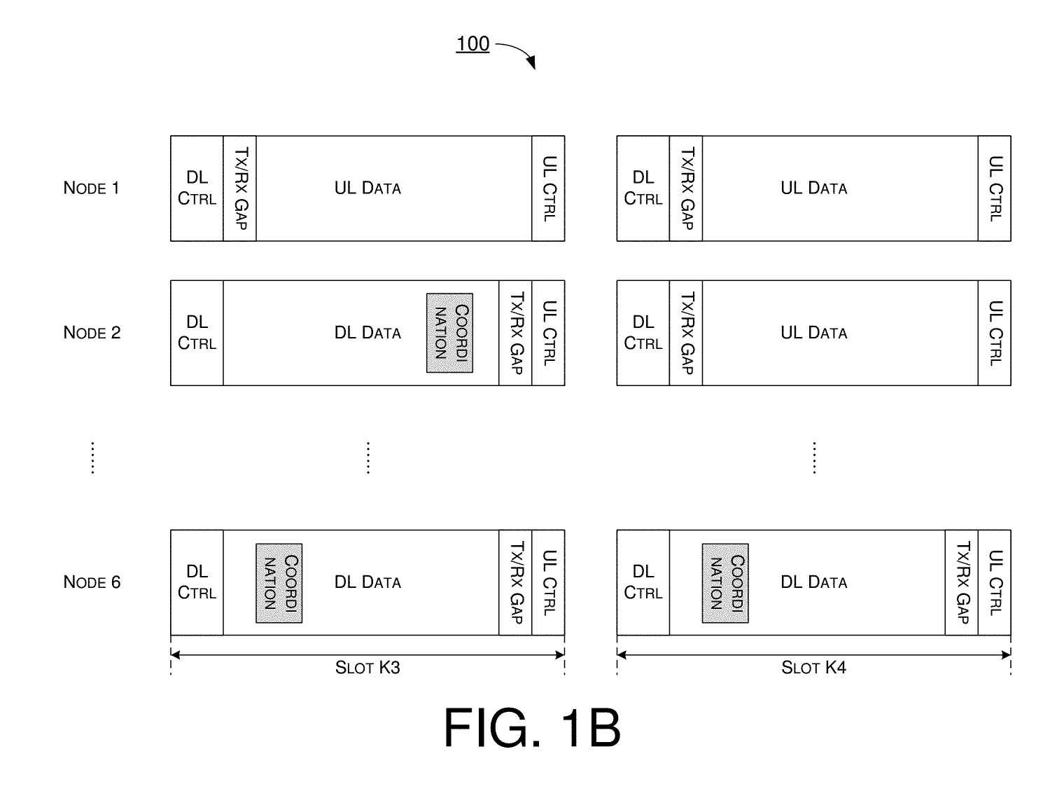

FIGS. 1A-1B illustrate an example scenario 100 under schemes in accordance with implementations of the present disclosure. Scenario 100 involves a plurality of nodes, which may be a part of a wireless communication network (e.g., a Long Term Evolution (LTE) network, a LTE-Advanced network, a LTE-Advanced Pro network, a 5^{th} Generation (5G) network, a New Radio (NR) network or an Internet of Things (IoT) network). The plurality of nodes may be capable of wirelessly communicating with each other via wireless signals. In wireless communication environment, the wireless signals transmitted or broadcasted by a node of a wireless network may cause interferences to neighbor nodes within neighbor areas. In order to prevent potential interferences, the plurality of nodes within neighbor areas may have to communicate and negotiate with each other to properly arrange radio resources. Accordingly, coordination information exchange among the plurality of nodes may be needed. The coordination information may comprise, for example and without limitation, slot format, uplink/downlink traffic amount, uplink/downlink resource split, channel state information (CSI) feedback, etc. In NR, mini-slot is newly introduced to carry control information or data information. The mini-slot may be configured to occupy a small time duration in time domain and a plurality of sub-carriers in frequency domain. For example, the time duration of the mini-slot may comprise at least one orthogonal frequency-division multiplexing (OFDM) symbol and less than the time duration of a sub-frame (e.g., 14 OFDM symbols). Thus, the node may be configured to use the mini-slot to transmit the coordination information among the plurality of nodes.

As showed in FIGS. 1A-1B, the coordination information is carried in mini-slot across slots (e.g., slot k1, k2, k3 and k4) for the plurality of nodes. In view of that the plurality of nodes may not always use the same slot type over slots, the node of the wireless network may need to sniff the possible coordination information transmitted from other nodes. For example, in slot k1, node 6 is in uplink (UL) reception and is able to sniff the mini-slot transmission from node 1 and node 2. In slot k2, node 2 and node 6 are in UL reception and are able to sniff the mini-slot transmission from node 1. Similarly, in slot k3, node 1 is in UL reception and is able to sniff the mini-slot transmission from node 2 and node 6. In slot k4, node 1 and node 2 are in UL reception and is able to sniff the mini-slot transmission from node 6.

In such implementation, the mechanism of multiplexing mini-slot and slots may be used to convey coordination information without introducing new types of slots. The coordination information is opportunistically transmitted and received. Such mechanism may also be used for the unlicensed spectrum such as 5 GHz unlicensed national information infrastructure (U-NII) radio band in US and the shared spectrum such as citizens broadband radio service (CBRS) radio band in US. However, the mini-slot transmission at one node may not be coordinated among other nodes and its timing and location in frequency domain may not be known in advance at other nodes. The complexity of blink detection at other nodes may be a huge burden. Especially in the unlicensed spectrum, the plurality of nodes in neighbor areas may not belong to the same operator network or service provider. The timing information of the nodes is not shared or aligned with each other. Without proper coordination information or timing information, the interferences among the nodes may become serious and uncontrollable.

On the other hand, an issue may also be identified in enhanced mobile broadband (eMBB) and ultra-reliable and low latency communications (URLLC) multiplexing. The URLLC transmission in the uplink from a UE may not be scheduled and/or pre-configured by its network apparatus. The URLLC transmission is determined and initiated by the UE. The network apparatus may have to monitor and detect the possible URLLC transmission from a UE. Similarly, the detection complexity and potential interferences may also be an issue in communication networks.

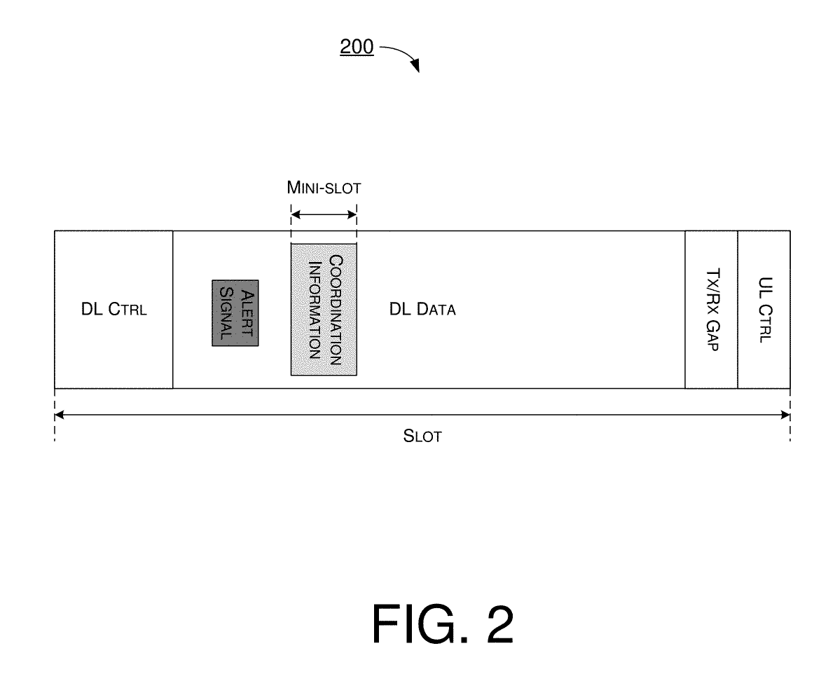

FIG. 2 illustrate an example scenario 200 under schemes in accordance with implementations of the present disclosure. Scenario 200 involves a first node and at least one second nodes, which may be a part of a wireless communication network (e.g., a Long Term Evolution (LTE) network, a LTE-Advanced network, a LTE-Advanced Pro network, a 5th Generation (5G) network, a New Radio (NR) network or an Internet of Things (IoT) network). The first node may be capable of wirelessly communicating with the second node via wireless signals. In order to reduce interferences caused by the second node, the first node may be capable of communicating and negotiating radio resource arrangements with the second node. Accordingly, the first node may be capable of exchanging coordination information with the second node. The coordination information may comprise, for example and without limitation, slot format, uplink/downlink traffic amount, uplink/downlink resource split, channel state information (CSI) feedback, etc. The first node and the second node may be configured to exchange the coordination information by using mini-slot. The mini-slot may occupy a specific time duration in time domain and a plurality of sub-carriers in frequency domain.

According to implementations of the present disclosure, an alert signal is introduced. As showed in FIG. 2, the alert signal may be received by the first node before the coordination information from the second node. The alert signal may be used to indicate the presence of the mini-slot transmission. Specifically, the alert signal may have simple structure and may comprise the information for indicating the mini-slot transmission. For example, the alert signal may comprise time-frequency information of the mini-slot carrying the coordination information. Alternatively, the alert signal may comprise a flag or an indicator for indicating that the mini-slot transmission exists or has occurred. After receiving the alert signal, the first node may be aware of the presence of the next coming mini-slot transmission. The first node may be configured to detect the mini-slot transmission according to the alert signal. The first node may further be configured to receive the mini-slot transmission from the second node. The mini-slot transmission may comprise coordination information from the second node.

The alert signal may have simple structure and may be configured with specific pattern or format. For example, the alert single may be consist of single tone or multiple tones (e.g., specific time-frequency location). The second node may be configured to transmit the alert signal with the specific pattern or format. Then, the first node may monitor or detect the alert signal according to the specific pattern or format. Since the pattern or format of the alert signal is pre-defined or pre-configured, the detection of the alert signal may be straightforward and easy. The first node may not need to perform burdensome blind detection and may use low efforts to detect and receive the alert signal. On the other hand, since the structure of the alert signal is simple, the signaling overhead of the alert signal may also be low. The pattern or format of the alert signal may be pre-configured by higher layer signaling (e.g., Radio Resource Control (RRC) layer signaling).

According, the alert signal may be used to inform the first node to receive the mini-slot transmission. With the preceding alert signal, the first node may not need to perform heavy blind detection for the mini-slot transmission which the node may not be aware of its presence. The first node may solely need to detect the alert signal with low effort search. With a positive detection of the alert signal, the first node may be able to extend effort for detecting and receiving the corresponding mini-slot transmission. By such design, the complexity of detecting and receiving the mini-slot transmission may be significantly reduced.

In some implementations, the alert signal may be concurrently transmitted with the mini-slot transmission. The first node may be configured to receive and process the alert signal first. Then, the first node may be further configured to determine whether to extent effort to process the mini-slot transmission according to the alert signal.

On the other hand, when the first node needs to transmit coordination information to the second node, the first node may be capable of transmitting the alert signal to the second node. The first node may be configured to transmit the coordination information by using mini-slot transmission. The alert signal may indicate the presence of the mini-slot transmission. The first node may be configured to perform the mini-slot transmission to the second node. The alert signal may be transmitted before the mini-slot transmission or may be concurrently transmitted with the mini-slot transmission.

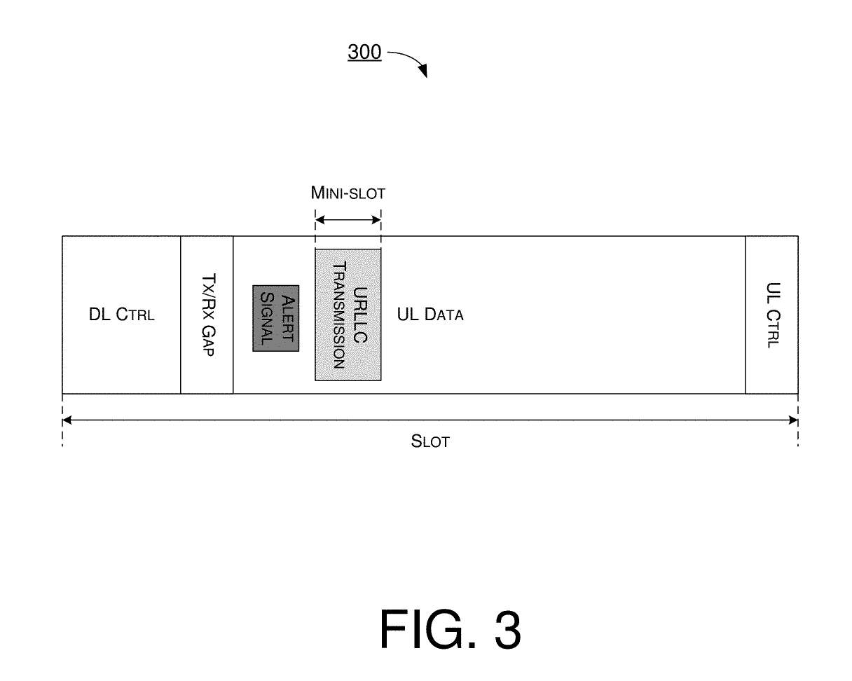

FIG. 3 illustrate an example scenario 300 under schemes in accordance with implementations of the present disclosure. Scenario 300 involves a UE and at least one network nodes, which may be a part of a wireless communication network (e.g., a Long Term Evolution (LTE) network, a LTE-Advanced network, a LTE-Advanced Pro network, a 5^{th} Generation (5G) network, a New Radio (NR) network or an Internet of Things (IoT) network). The UE may be capable of wirelessly communicating with the network node via wireless signals. The UE may be configured to multiplexing eMBB and URLLC transmission in a slot. The UE may be configured to transmit the URLLC transmission by using mini-slot transmission. The mini-slot may occupy a specific time duration in time domain and a plurality of sub-carriers in frequency domain.

As showed in FIG. 3, the UE may be configured to transmit an alert signal to the network apparatus. The alert signal may be transmitted before the mini-slot transmission or may be concurrently transmitted with the mini-slot transmission. The alert signal may be used to indicate the presence of the mini-slot transmission. Similarly, the alert signal may have simple structure and may comprise the information for indicating the mini-slot transmission. For example, the alert signal may comprise time-frequency information of the mini-slot carrying the URLLC transmission. Alternatively, the alert signal may comprise a flag or an indicator for indicating that the mini-slot transmission exists or has occurred. After receiving the alert signal, the network node may be aware of the presence of the next coming mini-slot transmission. The network node may be configured to detect the mini-slot transmission according to the alert signal. The network node may further be configured to receive the mini-slot transmission from the UE. The mini-slot transmission may comprise URLLC transmission from the UE.

The alert signal may have simple structure and may be configured with specific pattern or format. The pattern or format of the alert signal may be pre-configured by higher layer signaling (e.g., Radio Resource Control (RRC) layer signaling) from the network apparatus. The UE may be configured to transmit the alert signal with the specific pattern or format. Then, the network node may monitor or detect the alert signal according to the specific pattern or format.

According, the alert signal may be used by the UE to inform the network node to receive the URLLC transmission. With the preceding alert signal, the network node may not need to perform heavy blind detection for the URLLC transmission which the network node may not be aware of its presence. The network node may solely need to detect the alert signal with low effort search. With a positive detection of the alert signal, the network node may be able to extend effort for detecting and receiving the corresponding URLLC transmission. By such design, the complexity of detecting and receiving the URLLC transmission may be significantly reduced.

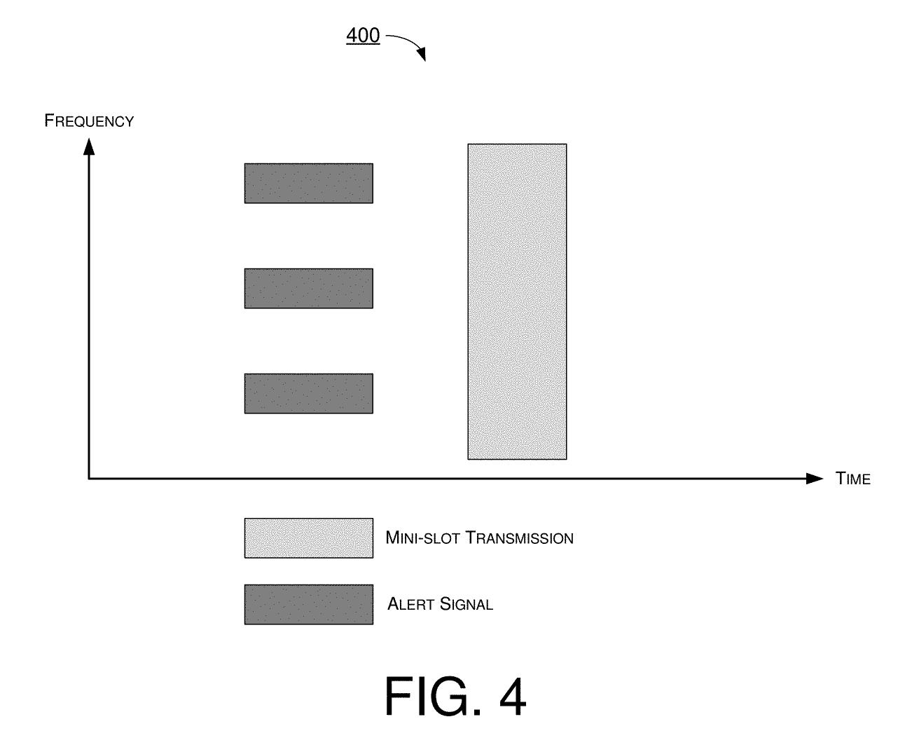

FIG. 4 illustrate an example scenario 400 under schemes in accordance with implementations of the present disclosure. Scenario 400 involves at least one node which may be a part of a wireless communication network. As showed in FIG. 4, a plurality of tones (e.g., three tones) may be used for transmitting the alert signals. Each tone of the alert signal may occupy a specific time-frequency region. The node may be configured to transmit the plurality of alerts signals before the mini-slot transmission. In general, one tone may be used for easy detection at an intended recipient. However, in order to avoid that a single tone may fall into a deep null due to frequency selectively fading effect, more than one tone transmission for the alert signals may be preferred and robust. The plurality of tones of the alert signals may also be concurrently transmitted with the mini-slot transmission.

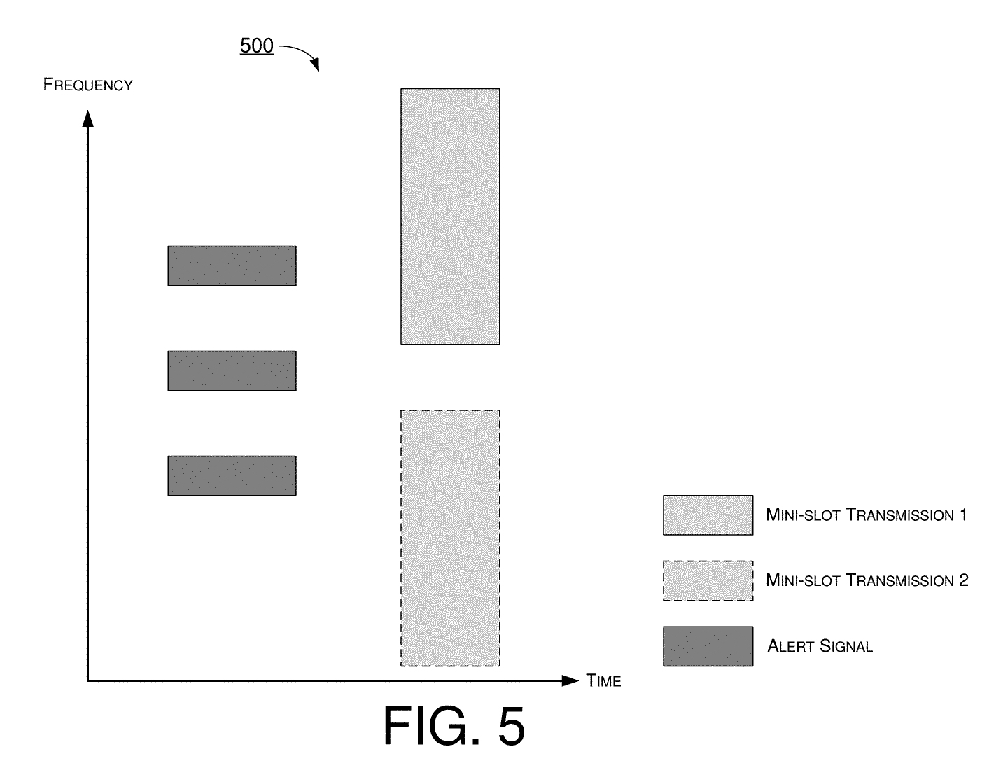

FIG. 5 illustrate an example scenario 500 under schemes in accordance with implementations of the present disclosure. Scenario 500 involves a plurality of nodes which may be a part of a wireless communication network. As showed in FIG. 5, the alert signals may not need to be aligned with the mini-slot transmission in frequency domain. The frequency locations of the alert signals may be different from the frequency locations of the mini-slot transmissions. Furthermore, one set of alert signals may be used to indicate two or more mini-slot transmissions. In other words, the alert signals for two or more mini-slot transmissions may be located at the same frequency location. As showed in FIG. 5, the alert signals may be used to indicate the presence of the mini-slot transmission 1 and the mini-slot transmission 2. One benefit of the design in FIG. 5 may be that the signaling overhead for the alert signals may be amortized and shared among a plurality of mini-slot transmissions. At the intended receiving node, once it detects the alert signals, it may attempt to detect the mini-slot transmission at a plurality of candidate time-frequency positions. For example, a first node may use the alert signals to indicate the presence of the mini-slot transmission 1. A second node may use the same alert signals to indication the presence of the mini-slot transmission 2. After receiving the alert signals, the intended receiving node may be configured to detect both the mini-slot transmission 1 and the mini-slot transmission 2 at different time-frequency locations. How many mini-slot transmissions may be indicated by one set of alert signals may be properly designed by considering the detection complexity and the signaling overheads. Furthermore, the timing gap between the alert signals and the mini-slot transmission may also be properly designed according to practical demands.

### Illustrative Implementations

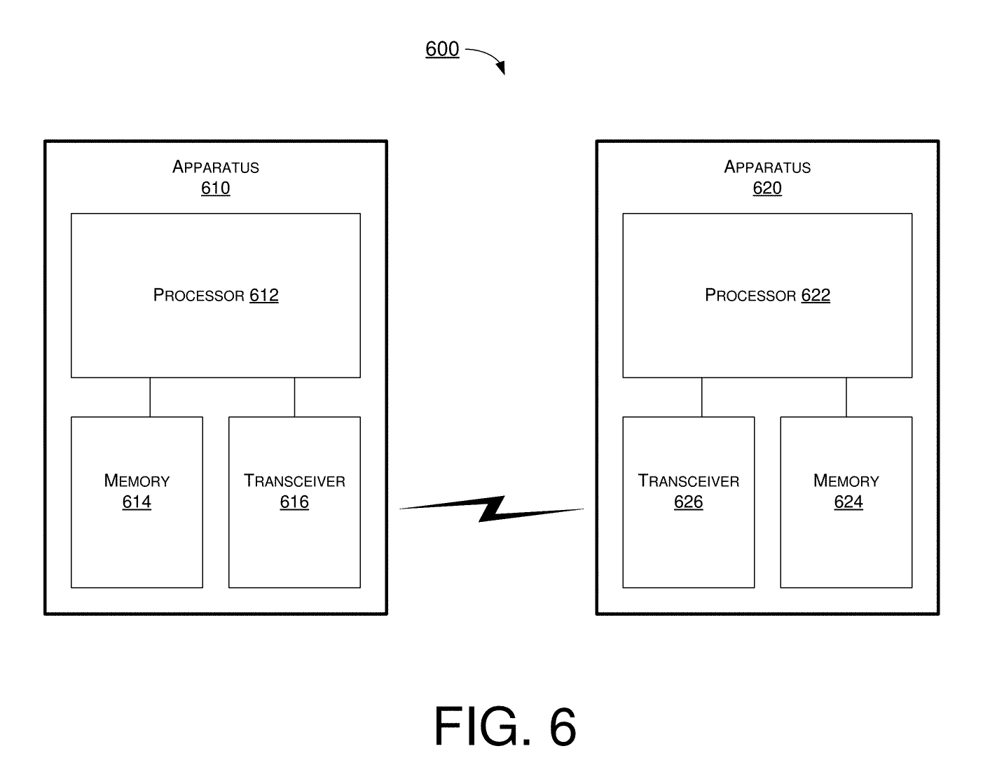

FIG. 6 illustrates an example system 600 having at least an example apparatus 610 and an example apparatus 620 in accordance with an implementation of the present disclosure. Each of apparatus 610 and apparatus 620 may perform various functions to implement schemes, techniques, processes and methods described herein pertaining to alert signal design in wireless communication systems, including the various schemes described above with respect to FIG. 1A-FIG. 5 described above as well as processes 700 and 800 described below.

Each of apparatus 610 and apparatus 620 may be a part of an electronic apparatus, which may be a network apparatus or a UE, such as a portable or mobile apparatus, a wearable apparatus, a wireless communication apparatus or a computing apparatus. For instance, each of apparatus 610 and apparatus 620 may be implemented in a smartphone, a smartwatch, a personal digital assistant, a digital camera, or a computing equipment such as a tablet computer, a laptop computer or a notebook computer. Each of apparatus 610 and apparatus 620 may also be a part of a machine type apparatus, which may be an IoT apparatus such as an immobile or a stationary apparatus, a home apparatus, a wire communication apparatus or a computing apparatus. For instance, each of apparatus 610 and apparatus 620 may be implemented in a smart thermostat, a smart fridge, a smart door lock, a wireless speaker or a home control center. When implemented in or as a network apparatus, apparatus 610 and/or apparatus 620 may be implemented in an eNodeB in a LTE, LTE-Advanced or LTE-Advanced Pro network or in a gNB or TRP in a 5G network, an NR network or an IoT network.

In some implementations, each of apparatus 610 and apparatus 620 may be implemented in the form of one or more integrated-circuit (IC) chips such as, for example and without limitation, one or more single-core processors, one or more multi-core processors, or one or more complex-instruction-set-computing (CISC) processors. In the various schemes described above with respect to FIG. 1A-FIG. 5, each of apparatus 610 and apparatus 620 may be implemented in or as a network apparatus or a UE. Each of apparatus 610 and apparatus 620 may include at least some of those components shown in FIG. 6 such as a processor 612 and a processor 622, respectively, for example. Each of apparatus 610 and apparatus 620 may further include one or more other components not pertinent to the proposed scheme of the present disclosure (e.g., internal power supply, display device and/or user interface device), and, thus, such component(s) of apparatus 610 and apparatus 620 are neither shown in FIG. 6 nor described below in the interest of simplicity and brevity.

In one aspect, each of processor 612 and processor 622 may be implemented in the form of one or more single-core processors, one or more multi-core processors, or one or more CISC processors. That is, even though a singular term “a processor” is used herein to refer to processor 612 and processor 622, each of processor 612 and processor 622 may include multiple processors in some implementations and a single processor in other implementations in accordance with the present disclosure. In another aspect, each of processor 612 and processor 622 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 612 and processor 622 is a special-purpose machine specifically designed, arranged and configured to perform specific tasks including those pertaining to alert signal design in wireless communication systems in accordance with various implementations of the present disclosure.

In some implementations, apparatus 610 may also include a transceiver 616 coupled to processor 612. Transceiver 616 may be capable of wirelessly transmitting and receiving data. In some implementations, apparatus 620 may also include a transceiver 626 coupled to processor 622. Transceiver 626 may include a transceiver capable of wirelessly transmitting and receiving data.

In some implementations, apparatus 610 may further include a memory 614 coupled to processor 612 and capable of being accessed by processor 612 and storing data therein. In some implementations, apparatus 620 may further include a memory 624 coupled to processor 622 and capable of being accessed by processor 622 and storing data therein. Each of memory 614 and memory 624 may include a type of random-access memory (RAM) such as dynamic RAM (DRAM), static RAM (SRAM), thyristor RAM (T-RAM) and/or zero-capacitor RAM (Z-RAM). Alternatively or additionally, each of memory 614 and memory 624 may include a type of read-only memory (ROM) such as mask ROM, programmable ROM (PROM), erasable programmable ROM (EPROM) and/or electrically erasable programmable ROM (EEPROM). Alternatively or additionally, each of memory 614 and memory 624 may include a type of non-volatile random-access memory (NVRAM) such as flash memory, solid-state memory, ferroelectric RAM (FeRAM), magnetoresistive RAM (MRAM) and/or phase-change memory.

In some implementations, each of processor 612 and processor 622 may be configured to exchange coordination information among a plurality of apparatus. The coordination information may comprise, for example and without limitation, slot format, uplink/downlink traffic amount, uplink/downlink resource split, channel state information (CSI) feedback, etc. In NR, mini-slot is newly introduced to carry control information or data information. The mini-slot may be configured to occupy a small time duration in time domain and a plurality of sub-carriers in frequency domain. Each of processor 612 and processor 622 may be configured to use the mini-slot to transmit the coordination information among the plurality of apparatus.

In some implementations, each of processor 612 and processor 622 may be configured to receive, via transceiver 616 or transceiver 626, an alert signal. The alert signal may be used to indicate the presence of the mini-slot transmission. The alert signal may have simple structure and may comprise the information for indicating the mini-slot transmission. After receiving the alert signal, each of processor 612 and processor 622 may be aware of the presence of the next coming mini-slot transmission. Each of processor 612 and processor 622 may be configured to detect the mini-slot transmission according to the alert signal. Each of processor 612 and processor 622 may further be configured to receive the mini-slot transmission. The mini-slot transmission may comprise coordination information from other apparatus.

In some implementations, the alert single may be consist of single tone or multiple tones (e.g., specific time-frequency location). The other apparatus may be configured to transmit the alert signal with the specific pattern or format. Then, each of processor 612 and processor 622 may monitor or detect the alert signal according to the specific pattern or format. Since the pattern or format of the alert signal is pre-defined or pre-configured, the detection of the alert signal may be straightforward and easy. Each of processor 612 and processor 622 may not need to perform burdensome blind detection and may use low efforts to detect and receive the alert signal. Each of processor 612 and processor 622 may receive the pattern or format of the alert signal by higher layer signaling (e.g., Radio Resource Control (RRC) layer signaling).

In some implementations, the alert signal may be used to inform processor 612 or processor 622 to receive the mini-slot transmission. With the preceding alert signal, each of processor 612 and processor 622 may not need to perform heavy blind detection for the mini-slot transmission which processor 612 or processor 622 may not be aware of its presence. Each of processor 612 and processor 622 may solely need to detect the alert signal with low effort search. With a positive detection of the alert signal, each of processor 612 and processor 622 may be able to extend effort for detecting and receiving the corresponding mini-slot transmission. By such design, the complexity of detecting and receiving the mini-slot transmission may be significantly reduced.

In some implementations, each of processor 612 and processor 622 may concurrently receive the alert signal and the mini-slot transmission. Each of processor 612 and processor 622 may be configured to receive and process the alert signal first. Then, each of processor 612 and processor 622 may be further configured to determine whether to extent effort to process the mini-slot transmission according to the alert signal.

In some implementations, each of processor 612 and processor 622 may be configured to transmit, via transceiver 616 or transceiver 626, the alert signal to other apparatus. Each of processor 612 and processor 622 may be configured to transmit the coordination information by using mini-slot transmission. The alert signal may indicate the presence of the mini-slot transmission. Each of processor 612 and processor 622 may be configured to transmit the alert signal before the mini-slot transmission or concurrently transmit the alert signal with the mini-slot transmission.

In some implementations, each of processor 612 and processor 622 may be configured to multiplex eMBB and URLLC transmission in a slot. Each of processor 612 and processor 622 may be configured to transmit the URLLC transmission by using mini-slot transmission. The mini-slot may occupy a specific time duration in time domain and a plurality of sub-carriers in frequency domain. Each of processor 612 and processor 622 may be configured to transmit an alert signal to other apparatus. Each of processor 612 and processor 622 may transmit the alert signal before the mini-slot transmission or may concurrently transmit the alert signal with the mini-slot transmission. The alert signal may be used to indicate the presence of the mini-slot transmission. The alert signal may comprise time-frequency information of the mini-slot carrying the URLLC transmission.

In some implementations, each of processor 612 and processor 622 may be configured to receive the alert signal. After receiving the alert signal, each of processor 612 and processor 622 may be aware of the presence of the next coming mini-slot transmission. Each of processor 612 and processor 622 may be configured to detect the mini-slot transmission according to the alert signal. Each of processor 612 and processor 622 may further be configured to receive the mini-slot transmission from other apparatus. The mini-slot transmission may comprise URLLC transmission from other apparatus.

In some implementations, the alert signal may be used by other apparatus to inform processor 612 or processor 622 to receive the URLLC transmission. With the preceding alert signal, each of processor 612 and processor 622 may not need to perform heavy blind detection for the URLLC transmission which processor 612 or processor 622 may not be aware of its presence. Each of processor 612 and processor 622 may solely need to detect the alert signal with low effort search. With a positive detection of the alert signal, each of processor 612 and processor 622 may be able to extend effort for detecting and receiving the corresponding URLLC transmission. By such design, the complexity of detecting and receiving the URLLC transmission may be significantly reduced.

In some implementations, each of processor 612 and processor 622 may be configured to use a plurality of tones (e.g., three tones) to transmit the alert signals. Each tone of the alert signal may occupy a specific time-frequency region. Each of processor 612 and processor 622 may be configured to transmit the plurality of alerts signals before the mini-slot transmission. Each of processor 612 and processor 622 may also transmit the plurality of tones of the alert signals with the mini-slot transmission.

In some implementations, the alert signals may not need to be aligned with the mini-slot transmission in frequency domain. The frequency locations of the alert signals may be different from the frequency locations of the mini-slot transmissions. Furthermore, one set of alert signals may be used to indicate two or more mini-slot transmissions. In other words, the alert signals for two or more mini-slot transmissions may be located at the same frequency location. Once such the alert signals are detected, each of processor 612 and processor 622 may attempt to detect the mini-slot transmission at a plurality of candidate time-frequency positions. For example, a first node may use the alert signals to indicate the presence of a first mini-slot transmission. A second node may use the same alert signals to indication the presence of a second mini-slot transmission. After receiving the alert signals, each of processor 612 and processor 622 may be configured to detect both the first mini-slot transmission and the second mini-slot transmission at different time-frequency locations.

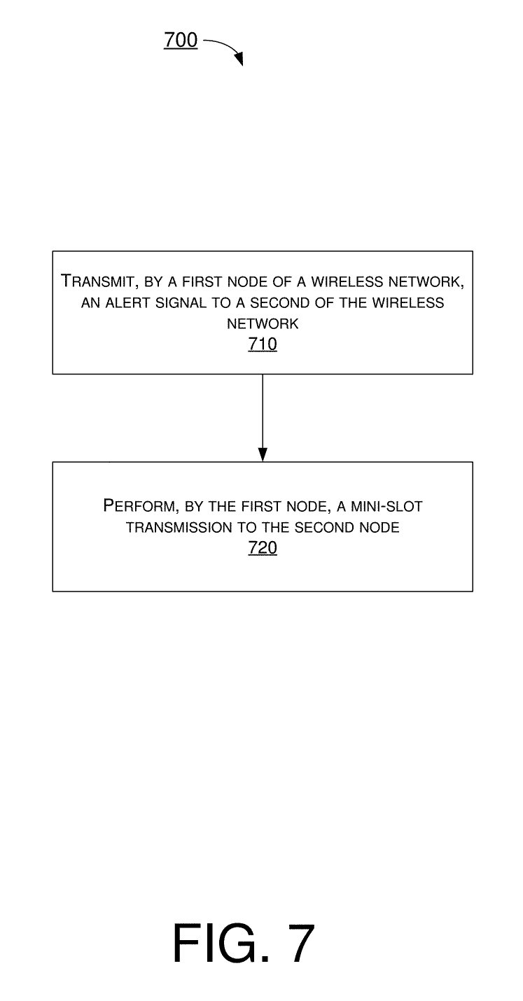

FIG. 7 illustrates an example process 700 in accordance with an implementation of the present disclosure. Process 700 may represent an aspect of implementing the proposed concepts and schemes such as one or more of the various schemes described above with respect to FIG. 1-FIG. 6. More specifically, process 700 may represent an aspect of the proposed concepts and schemes pertaining to alert signal design in wireless communication systems. For instance, process 700 may be an example implementation, whether partially or completely, of the proposed schemes described above for alert signal design in wireless communication systems. Process 700 may include one or more operations, actions, or functions as illustrated by one or more of blocks 710 and 720. Although illustrated as discrete blocks, various blocks of process 700 may be divided into additional blocks, combined into fewer blocks, or eliminated, depending on the desired implementation. Moreover, the blocks/sub-blocks of process 700 may be executed in the order shown in FIG. 7 or, alternatively in a different order. The blocks/sub-blocks of process 700 may be executed iteratively. Process 700 may be implemented by or in apparatus 610 and/or apparatus 620 as well as any variations thereof. Solely for illustrative purposes and without limiting the scope, process 700 is described below in the context of apparatus 610 and apparatus 620. Process 700 may begin at block 710.

At 710, process 700 may involve apparatus 610, as a first node of a wireless network, transmitting an alert signal to apparatus 620 as a second node of the wireless network. Process 700 may proceed from 710 to 720.

At 720, process 700 may involve apparatus 610 performing a mini-slot transmission to apparatus 620.

In some implementations, the alert signal may indicate presence of the mini-slot transmission. Process 700 may involve apparatus 610 transmitting the alert signal by a plurality tones. The mini-slot transmission may comprise coordination information of apparatus 610. Alternatively, the mini-slot transmission may comprise ultra-reliable low latency communications (URLLC) of apparatus 610.

In some implementations, process 700 may involve apparatus 610 transmitting the alert signal before the mini-slot transmission or concurrently transmitting the alert signal with the mini-slot transmission. Process 700 may involve apparatus 610 transmitting the alert signal with specific pattern or format.

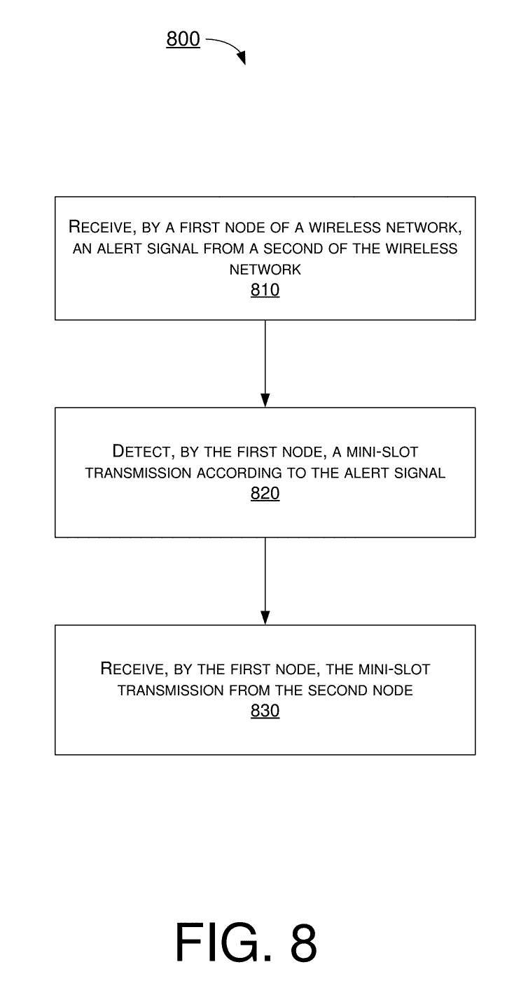

FIG. 8 illustrates an example process 800 in accordance with an implementation of the present disclosure. Process 800 may represent an aspect of implementing the proposed concepts and schemes such as one or more of the various schemes described above with respect to FIG. 1-FIG. 6. More specifically, process 800 may represent an aspect of the proposed concepts and schemes pertaining to alert signal design in wireless communication systems. For instance, process 800 may be an example implementation, whether partially or completely, of the proposed schemes described above for alert signal design in wireless communication systems. Process 800 may include one or more operations, actions, or functions as illustrated by one or more of blocks 810, 820 and 830. Although illustrated as discrete blocks, various blocks of process 800 may be divided into additional blocks, combined into fewer blocks, or eliminated, depending on the desired implementation. Moreover, the blocks/sub-blocks of process 800 may be executed in the order shown in FIG. 8 or, alternatively in a different order. The blocks/sub-blocks of process 800 may be executed iteratively. Process 800 may be implemented by or in apparatus 610 and/or apparatus 620 as well as any variations thereof. Solely for illustrative purposes and without limiting the scope, process 800 is described below in the context of apparatus 610 and apparatus 620. Process 800 may begin at block 810.

At 810, process 800 may involve apparatus 610, as a first node of a wireless network, receiving an alert signal from apparatus 620 as a second node of the wireless network. Process 800 may proceed from 810 to 820.

At 820, process 800 may involve apparatus 610 detecting a mini-slot transmission according to the alert signal. Process 800 may proceed from 820 to 830.

At 830, process 800 may involve apparatus 610 receiving the mini-slot transmission from apparatus 620.

In some implementations, the alert signal may indicate presence of the mini-slot transmission. Process 800 may involve apparatus 610 receiving the alert signal by receiving a single tone or a plurality tones. The mini-slot transmission may comprise coordination information from apparatus 620. Alternatively, the mini-slot transmission may comprise ultra-reliable low latency communications (URLLC) from apparatus 620.

In some implementations, process 800 may involve apparatus 610 receiving the alert signal received before the mini-slot transmission or concurrently receiving the alert signal with the mini-slot transmission. Process 800 may involve apparatus 610 monitoring or detecting the alert signal according to specific pattern or format. Process 800 may not need to involve apparatus 610 performing burdensome blind detection and may involve apparatus 610 using low efforts to detect and receive the alert signal. Process 800 may further involve apparatus 610 receiving the pattern or format of the alert signal by higher layer signaling (e.g., Radio Resource Control (RRC) layer signaling).

In some implementations, process 800 may not involve apparatus 610 perform heavy blind detection for the mini-slot transmission which apparatus 610 may not be aware of its presence. Process 800 may involve apparatus 610 detecting the alert signal with low effort search. With a positive detection of the alert signal, process 800 may involve apparatus 610 extending effort for detecting and receiving the corresponding mini-slot transmission.

In some implementations, process 800 may involve apparatus 610 detecting a plurality of mini-slot transmissions according to the alert signal. Process 800 may further involve apparatus 610 receiving the plurality of mini-slot transmissions. The alert signal may indicate presence of the plurality of mini-slot transmissions.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
transmitting, by a first node of a wireless network, an alert signal to a second node of the wireless network; and
performing, by the first node, a mini-slot transmission to the second node,
wherein the alert signal indicates presence of the mini-slot transmission.

2. The method of claim 1, wherein the first node transmits the alert signal by a plurality tones.

3. The method of claim 1, wherein the alert signal is transmitted before the mini-slot transmission.

4. The method of claim 1, wherein the alert signal is concurrently transmitted with the mini-slot transmission.

5. A method, comprising:
receiving, by a first node of a wireless network, an alert signal from a second node of the wireless network;
detecting, by the first node, a mini-slot transmission according to the alert signal; and
receiving, by the first node, the mini-slot transmission from the second node,
wherein the alert signal indicates presence of the mini-slot transmission.

6. The method of claim 5, wherein the alert signal is received before the mini-slot transmission.

7. The method of claim 5, wherein the alert signal is concurrently received with the mini-slot transmission.

8. The method of claim 5, wherein the mini-slot transmission comprises coordination information from the second node.

9. The method of claim 5, wherein the mini-slot transmission comprises ultra-reliable low latency communications (URLLC) from the second node.

10. The method of claim 5, further comprising:
detecting, by the first node, a plurality of mini-slot transmissions according to the alert signal; and
receiving, by the first node, the plurality of mini-slot transmissions,
wherein the alert signal indicates presence of the plurality of mini-slot transmissions.

11. An apparatus, comprising:
a transceiver capable of wirelessly communicating with other apparatus of a wireless network; and
a processor communicatively operably coupled to the transceiver, the processor capable of:
transmitting, via the transceiver, an alert signal to the other apparatus; and
performing, via the transceiver, a mini-slot transmission to the other apparatus,
wherein the alert signal indicates presence of the mini-slot transmission.

12. The apparatus of claim 11, wherein the processor is capable of transmitting the alert signal by a plurality tones.

13. The apparatus of claim 11, wherein the processor is capable of transmitting the alert signal before the mini-slot transmission.

14. The apparatus of claim 11, wherein the processor is capable of transmitting the alert signal concurrently with the mini-slot transmission.

15. An apparatus, comprising:
a transceiver capable of wirelessly communicating with other apparatus of a wireless network; and
a processor communicatively operably coupled to the transceiver, the processor capable of:
receiving, via the transceiver, an alert signal from the other apparatus;
detecting a mini-slot transmission according to the alert signal; and
receiving, via the transceiver, the mini-slot transmission from the other apparatus,
wherein the alert signal indicates presence of the mini-slot transmission.

16. The apparatus of claim 15, wherein the processor is capable of receiving the alert signal before the mini-slot transmission.

17. The apparatus of claim 15, wherein the processor is capable of receiving the alert signal concurrently with the mini-slot transmission.

18. The apparatus of claim 15, wherein the mini-slot transmission comprises coordination information from the other apparatus.

19. The apparatus of claim 15, wherein the mini-slot transmission comprises ultra-reliable low latency communications (URLLC) from the other apparatus.

20. The apparatus of claim 15, wherein the processor is further capable of:
detecting a plurality of mini-slot transmissions according to the alert signal; and
receiving, via the transceiver, the plurality of mini-slot transmissions,
wherein the alert signal indicates presence of the plurality of mini-slot transmissions.
